(19) United States
(12) Patent Application Publication
(10) Pub. No.: US 2018/0125732 A1
(43) Pub. Date: May 10, 2018

(54) Telescoping Stretcher

(71) Applicant: Robert Lauritano, Watertown, NY (US)

(72) Inventor: Robert Lauritano, Watertown, NY (US)

(21) Appl. No.: 15/346,734

(22) Filed: Nov. 9, 2016

(51) Int. Cl. A61G 1/013; A61G 1/044

(52) U.S. Cl. CPC A61G 1/013; A61G 2205/20; A61G 1/044

(57) ABSTRACT

The present invention is a Telescoping Litter/Portable Collapsing Stretcher idea, The stretcher would be collapse-able and “telescope” down into a smaller size when not in use. The stretcher has three main components. An internal support structure capable of telescoping into itself or collapsing onto itself, and with the ability to be “locked” and “unlocked” as needed. A removable outer shells or panels. A set of “spider straps” used to secure the patient to the stretcher. It would have hand holds and can be used with straps to hold a patient in place.

### BACKGROUND

### 1. Field of the Invention

The invention relates generally to a stretcher device, and in particular to one that is collapsible.

### 2. Description of Prior Art

The burgeoning elderly population has bolstered demand for ambulance services, due to this demographics' heavy use of emergency healthcare services compared with other age groups. The increased usage of smartphones, factory-installed vehicle communication & infotainment products, the risk of severe weather, and general car accidents will drive growth in the emergency services which in turn drives the need for stretchers to assist with the sick and wounded increasing the use and need for stretchers.

Stretchers, currently, are bulky, hard to use and take up too much room for storage and transport.

There is still room for improvement in the art.

### SUMMARY OF THE INVENTION

The present invention is a Telescoping Litter/Portable Collapsing Stretcher idea. A “litter” is a military term for a stretcher apparatus used to carry a patient from the field to an ambulance. This invention would be collapse-able and “telescope” down into a smaller size when not in use. It would also have pockets for various medical equipment incorporated into the design.

As for the structure: the stretcher has three main components. The first component is an internal support structure made of either metal or plastic materials capable of holding a minimum of 300 lbs, capable of telescoping into itself or collapsing onto itself, and with the ability to be “locked” and “unlocked” as needed. The second component is a set of removable outer shells or panels made of a plastic material, which is both heat/cold resistant, able to sustain its functionality when introduced to austere environments/elements, and can be rapidly cleaned by the user for future tasks. The third component is a “spider strap” used to secure the patient to the stretcher device. The straps would be color coded to quickly indicate which buckle fits to which buckle attachment on the stretcher.

The current invention is more efficient, effective and functional than the current art.

### BRIEF DESCRIPTION OF THE DRAWINGS

Without restricting the full scope of this invention, the preferred form of this invention is illustrated in the following drawings:

FIG. 1 shows a top view of the stretcher with the stretcher collapsed;

FIG. 2 shows a bottom view of the stretcher with the stretcher collapsed;

FIGS. 3 and 4 shows sides view of the stretcher with the stretcher collapsed;

FIG. 5 shows a front view of the stretcher with the stretcher collapsed;

FIG. 6 shows a top view of the stretcher with the stretcher expanded;

FIG. 7 shows a top view of the stretcher with the stretcher expanded with straps to hold a body;

FIG. 8 shows a bottom view of the stretcher with the stretcher expanded;

FIG. 9 shows a side view of the stretcher with the stretcher expanded; and

FIG. 10 shows a front view of the stretcher with the stretcher expanded.

### DESCRIPTION OF THE PREFERRED EMBODIMENT

There are a number of significant design features and improvements incorporated within the invention.

The current invention is directed to Telescoping Litter/Portable Collapsing Stretcher idea. It is a stretcher apparatus used to carry a patient from one point to another.

The stretcher 1 would be collapse-able and “telescope” down into a smaller size when not in use. It would also have pockets for various medical equipment incorporated into the design.

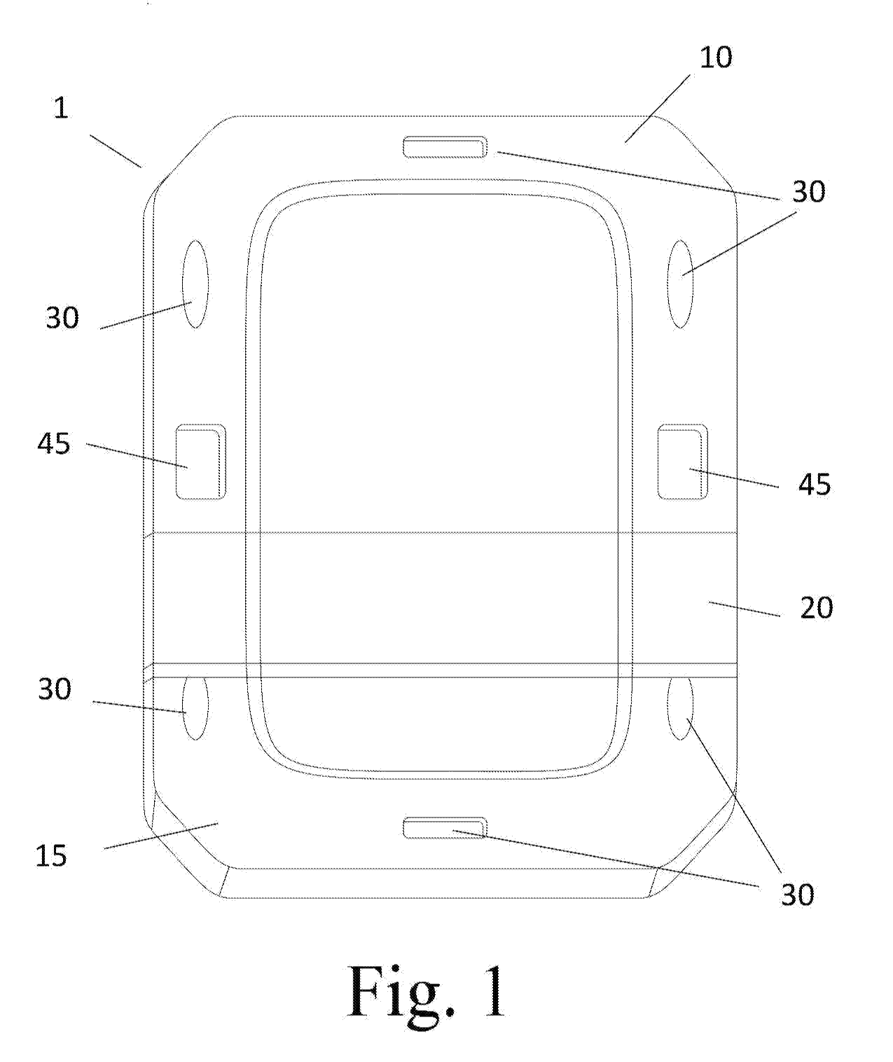

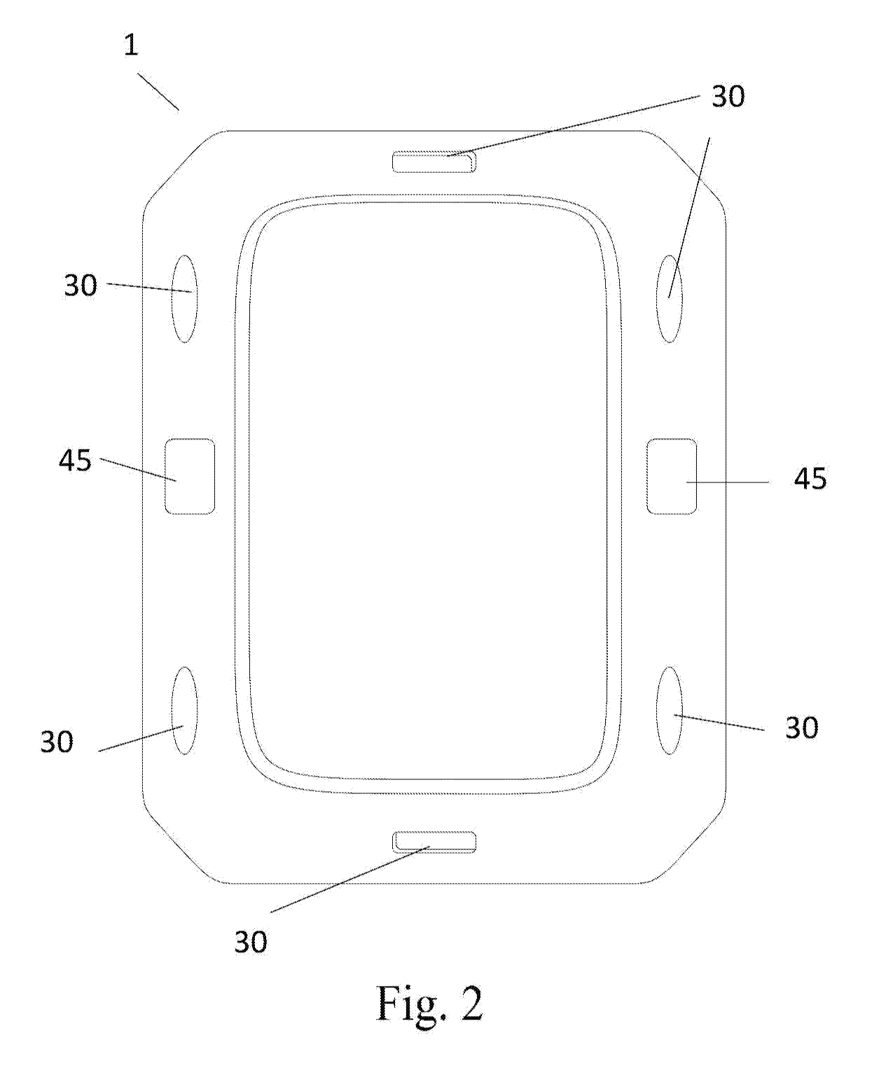

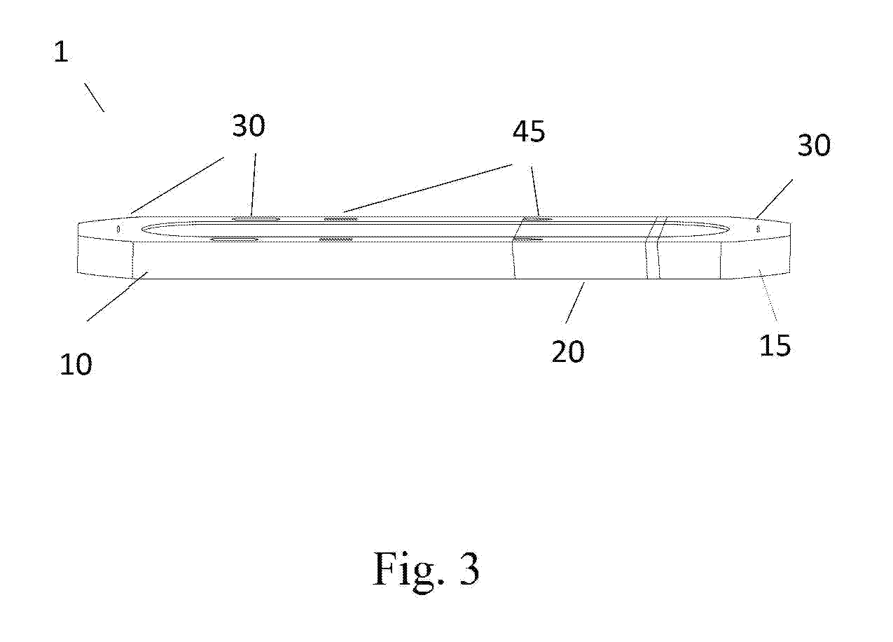

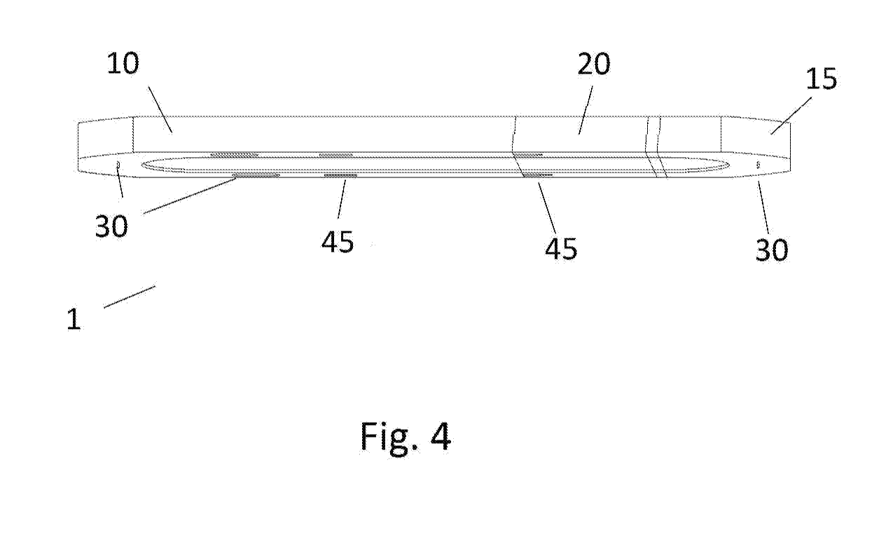

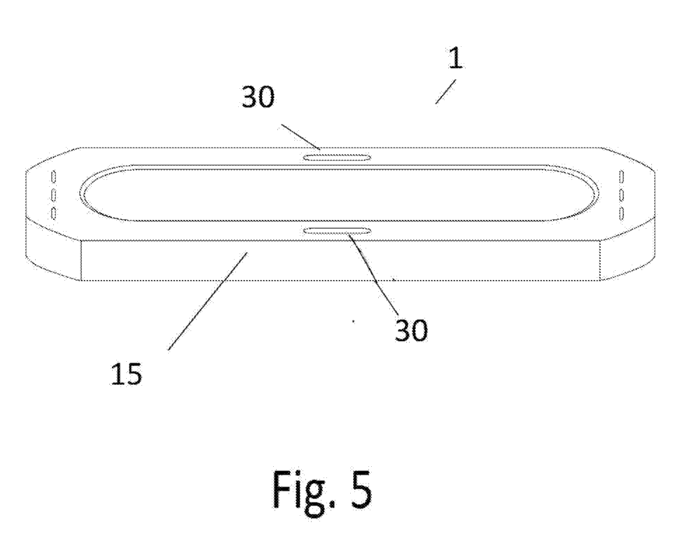

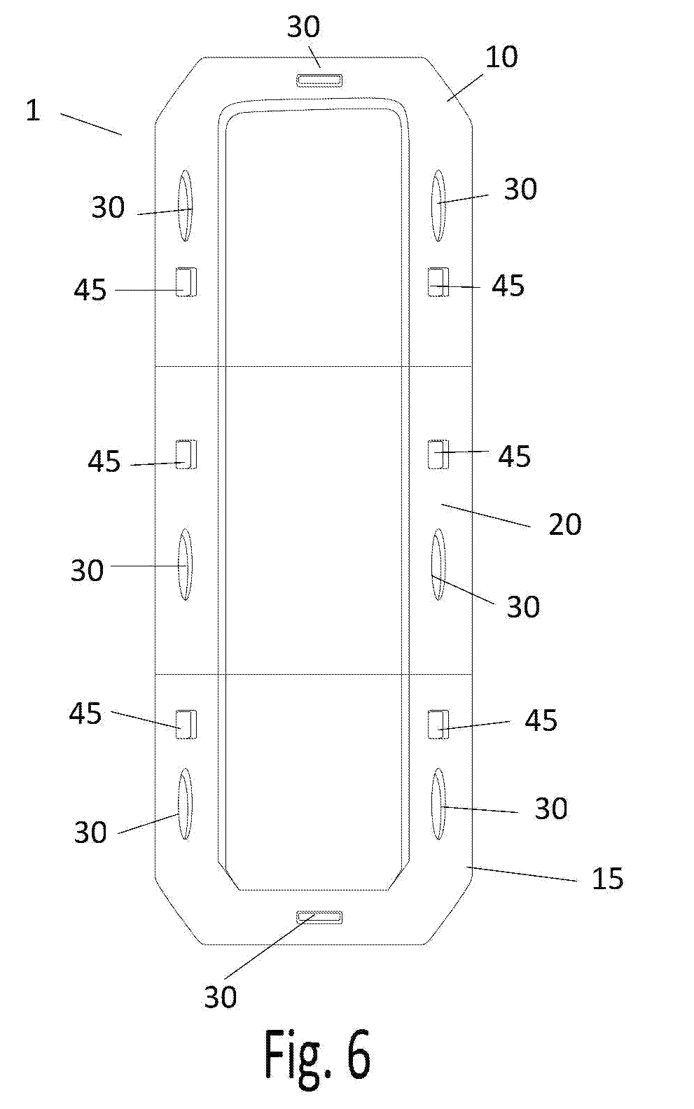

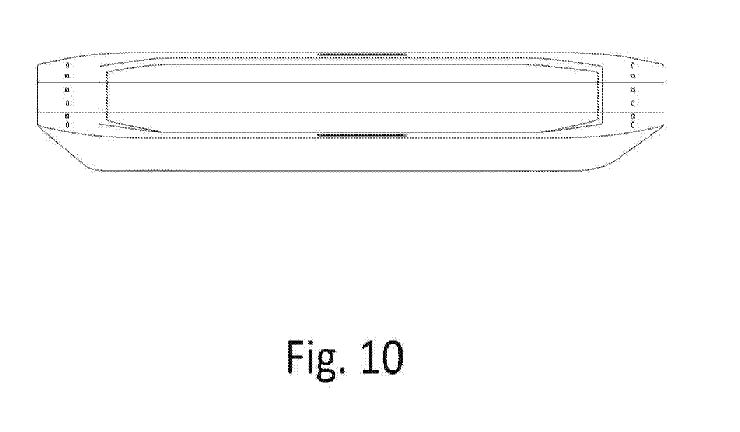

While collapsed, as shown in FIGS. 1 through 5, the stretcher 1 would take up less room, be easier to store and transport. When expanded, as shown in FIGS. 6 through 10, the stretcher 1 expands out to a full size stretcher 1 which can be used to carry an injured or sick person.

The stretcher 1 has three main components.

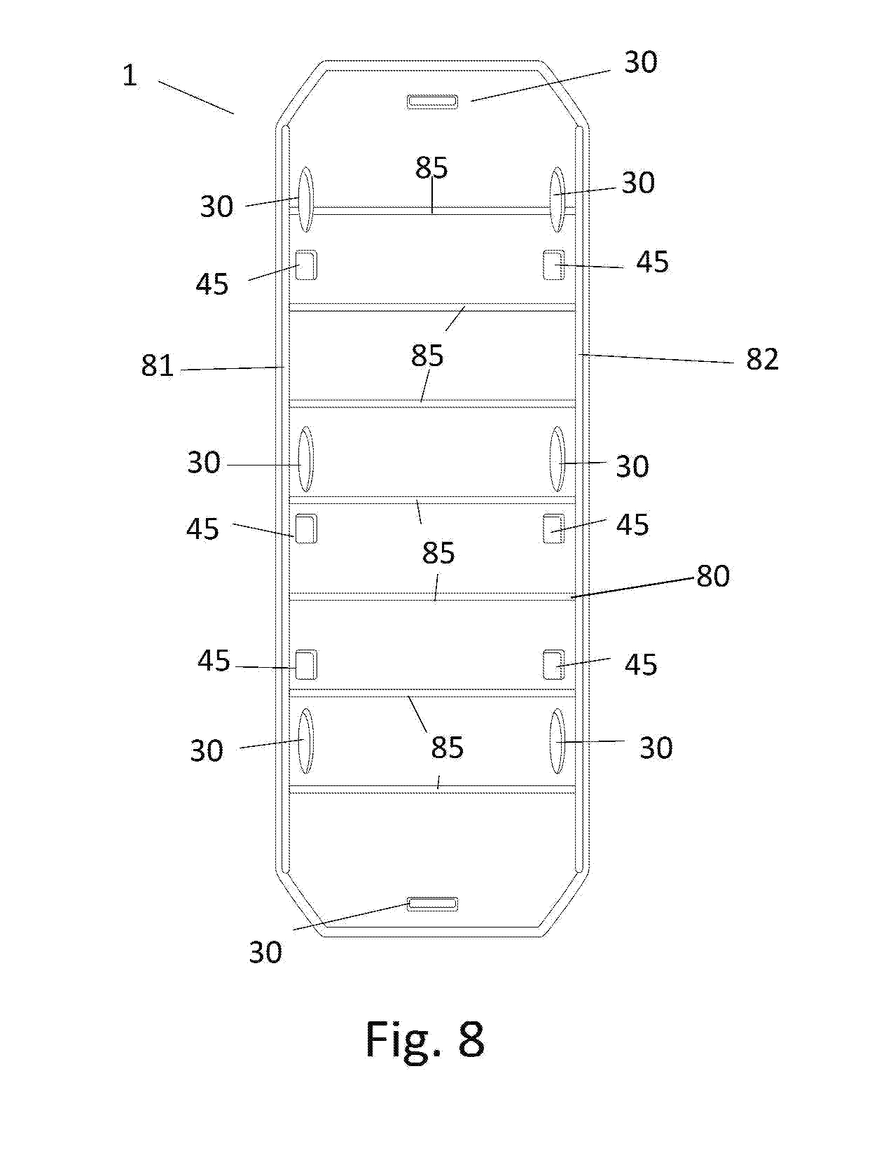

The first component is an internal support structure as shown in FIG. 8 made of either metal or plastic materials capable of holding a minimum of 3001bs, capable of telescoping into itself or collapsing onto itself, and with the ability to be “locked” and “unlocked” as needed.

The second component is a set of removable outer shells or panels (10, 15, 20) made of a plastic material, which is both heat/cold resistant, able to sustain its functionality when introduced to austere environments/elements, and can be rapidly cleaned by the user for future tasks.

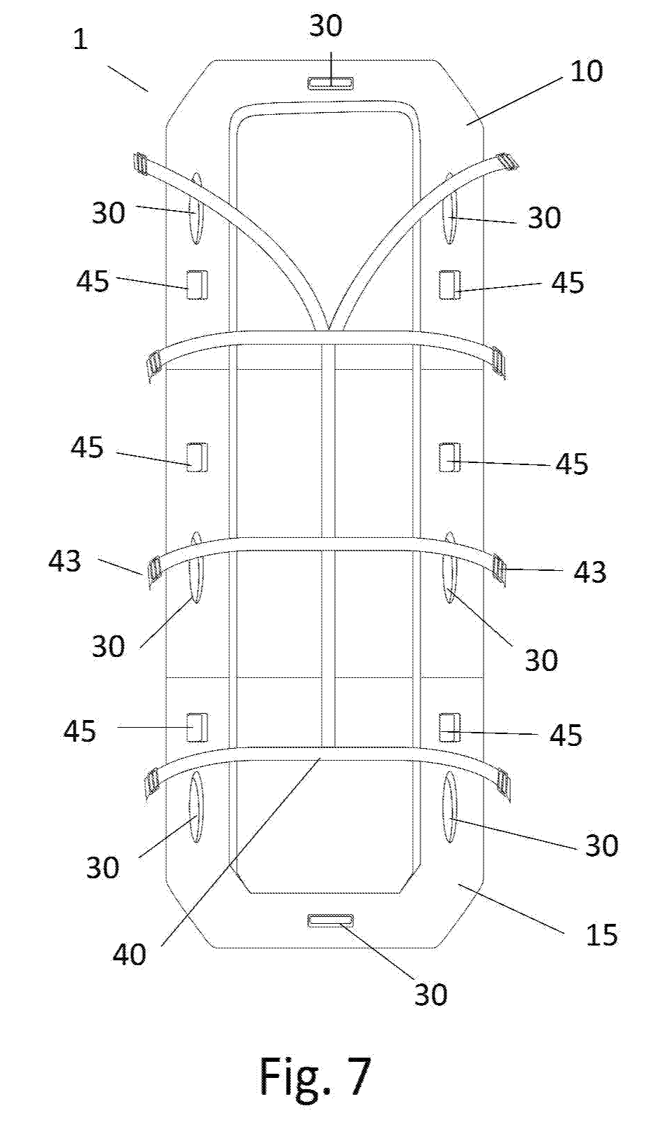

As shown in FIG. 7. The third component is a “spider strap” 40 used to secure the patient to the stretcher device. The straps 40 would be color coded to quickly indicate which buckle fits to which buckle attachment 43 on the stretcher 1.

The stretcher 1 is supported by the support structure 80 which is located on the bottom of the stretcher 1 as shown in FIG. 8. It is made of metal or a strong plastic to supply the strength and support needed to carry someone in the stretcher 1. It can be outside or inside of the sections. There are two side bars (81 and 82) that are located along the outside edges of the sections with a plurality of cross bars 85 that connect to the side bars (81, 82). The cross bars 85 connect to the side bars (81 and 82) at the perpendicular angle in the preferred embodiment. The support frame is collapsible just like the sections by either have a hinge means or having the frame 80 being comprised of multiple sections that connect to each other. The frame is stored within the collapsed sections when not in use.

The stretcher's outer shells or panels (10, 15, 20) has a number of sections, two end sections, a top section 10 and a bottom section 15 with one or more middle sections 20. In the preferred embodiment there are two end sections (10, 15) and one middle section 20 as shown in FIG. 6.

As shown in FIG. 1, the sections collapse into each to other for storage and transportation. The bottom end 15 fits into the middle section 20 which fits into the top end 10. There can be one or more middle sections 20. If there is more than one than one middle section 20 then middle sections 20 would collapse into another middle section 20 towards one of the end sections.

The middle section(s) 20 are rectangular in shape with a top and bottom and two thin solid outside thin sides. The end sections (10 and 15) are rectangular in shape with tapered or round corners with solid thin outside sides that go around sides and the top on the top section 10 and bottom on the bottom section 15. The tapered or round corners are for safety to make sure that there are no sharp edges that could hurt someone.

The outer shells or panels sections would be made of a sturdy hard plastic but could be made of other materials such as a light weight metal like aluminum or cloth around a frame.

The sections will have hand hold openings 30 to allow the people using the stretcher 1 to have a better hold on the stretcher 1. The hand hold openings 30 are placed along the edge of the sections including the top and the bottom. The hand hold opening 30 have rounded edges and are open holes in the sections.

The stretcher 1 is design so that it will work with straps 40 that will hold the person on the stretcher 1. The straps 40, in the preferred embodiment, will go across the foot/leg area, the waist area, the chest areas and two straps will go over the shoulder areas as shown in FIG. 7. The straps will be adjustable using an adjustment means like buckle attachments 43 and will connect under the stretcher 1. The stretcher 1, in the preferred embodiment, will have strap slots 45 into which the straps 40 are placed. The strap slots 45 hold the straps 40 in their proper place and position while eliminating undesired movement of the straps 40.

The stretcher 1 would have pockets for various medical equipment incorporated into the design.

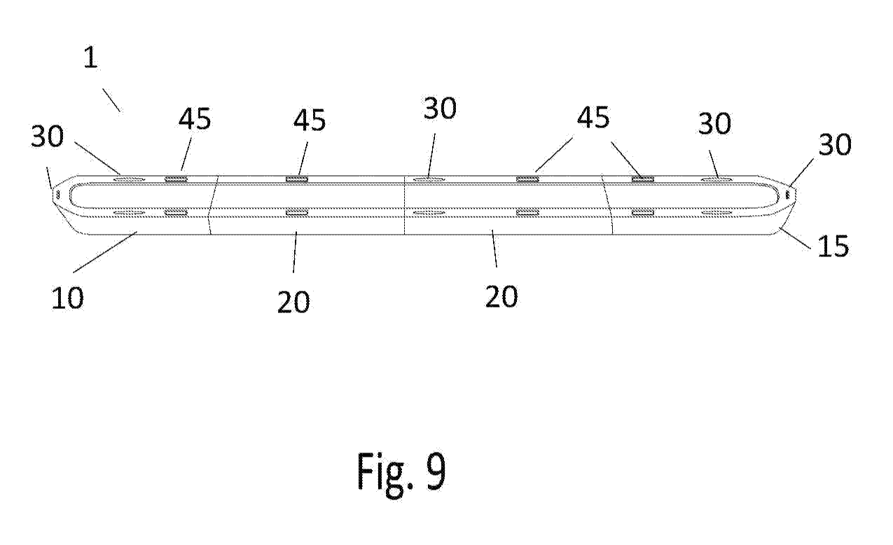

FIG. 9 shows the current invention with multiple middle sections 20.

The stretcher 1 is designed to be transported in the collapsed configuration either in hand or in a backpack. When the user is ready to put the stretcher 1 into operation, the user should be able to (1) place one of his/her feet into the handhold at the end of the stretcher 1 (2) grasp both sides of the outermost shell and (3) pull the outermost shell upwards to extend each panel out of each other until the device is fully extended and locked into position as shown in FIG. 6.

### Advantages

The unique features of this product will provide the following benefits:

Collapsible,

Quickly folds out, and

Straps to secure the patients.

While the methods disclosed herein have been described and shown with reference to particular steps performed in a particular order, it is understood that these steps may be combined, sub-divided, or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple variations of a mechanism unless noted otherwise. For example, when a connection is disclosed in one embodiment, the scope of the embodiment is intended to also cover the use of multiple connections.

Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a stretcher with an internal support structure and a plurality of removable panels.

2. A device according to claim 1 comprising:
said panels comprises two end sections with a plurality of middle sections.

3. A device according to claim 1 comprising:
having middle sections side into one of the end section with the other end section siding into one of the middle sections.

4. A device according to claim 3 comprising:
having the sections be rectangular in shape.

5. A device according to claim 1 comprising:
having a support frame that telescopes into itself.

6. A device according to claim 5 comprising:
having the support structure comprised of two side bars with a plurality of cross bars that connect to one side bars to another.

7. A device according to claim 6 comprising:
having the cross bars connect to the side bars at the perpendicular angle.

8. A device according to claim 1 comprising:
having the end sections have tapered corners.

9. A device according to claim 1 comprising:
having a plurality of hand hold openings in the end and middle sections.

10. A device according to claim 1 comprising:
having a plurality of straps.

11. A device according to claim 10 comprising:
having the strap be adjustable.

12. A device according to claim 10 comprising:
having a plurality of strap slots in the end and middle sections.

13. A device according to claim 10 comprising:
having the strap go through strap slots.

14. A device according to claim 1 comprising:
having a support frame with the ability to be locked and unlocked.

15. A device according to claim 10 comprising:
having the straps be color coded.

16. A device according to claim 15 comprising:
having strap attachments that are color coded to match the straps.

17. A device comprising:
a stretcher with an internal support structure and a plurality of removable panels,
said panels comprises two end sections with a plurality of middle sections, having the support frame that telescopes into itself, and having a plurality of adjustable straps.

18. A device according to claim 5 comprising:
having the support structure comprised of two side bars with a plurality of cross bars that connect to one side bars to another; and having the cross bars connect to the side bars at the perpendicular angle.

19. A device according to claim 10 comprising:
having the straps be color coded and having strap attachments that are color coded to match the straps.

20. A process according to claim 17 comprising:
using the stretcher to carry a person.
